(19) United States
(12) Patent Application Publication
(10) Pub. No.: US 2022/0042638 A1
(43) Pub. Date: Feb. 10, 2022

(54) Zuführeinheit für Fügeelemente mit einer Anschlusskupplung und Verfahren zum Verbinden/Trennen von Teilen einer Zuführeinheit für Fügelemente

(71) Applicant: IVOSTUD GmbH, Breckerfeld (DE)

(72) Inventors: Carsten Zenker, Gevelsberg (DE); Eduard Kirchner, Kehl (DE)

(73) Assignee: IVOSTUD GmbH, Breckerfeld (DE)

(21) Appl. No.: 17/266,182

(22) PCT Filed: Aug. 2, 2019
(86) PCT No.: PCT/DE2019/100707

§ 371 Date: Aug. 24, 2021

(30) Foreign Application Priority Data
Aug. 6, 2018 (DE) 10 2018 119 089.1

(51) Int. Cl. F16L 37/47; B23K 9/20

(52) U.S. Cl. CPC F16L 37/47; B23K 9/206

(57) ABSTRACT

A feeding unit for joining elements includes a connector coupling having a connector plug and a connector socket which may be placed in a connected state or disconnected state with respect to each other. The connector plug has a passage formed around a passage axis Z_{S}. The connector socket likewise has a passage formed around a passage axis Z_{B}. In the connected state of the connector plug and connector socket, the axes Z_{S} and Z_{B} are aligned with each other along an alignment axis Z_{F} to allow the flow of joining elements through the connector coupling. When the connector plug and socket are placed in the disconnected state, a locking element of the connector plug moves to a locked position to block joining elements from passing through the disconnected coupling socket.

### TECHNICAL FIELD OF THE INVENTION

The present invention relates to joining element feeding units with a connector coupling, wherein the connector coupling makes it possible to connect/disconnect two parts of the feeding unit without joining elements being able to come out in the disconnected state. The present invention also relates to methods for connecting/disconnecting parts of a feeding unit according to the invention by means of the connector coupling.

### BACKGROUND OF THE INVENTION

It is common to install small parts using industrial robots. For example, in automobile production, grounding studs or fastening studs are installed in a vehicle body shell by means of stud welding. For this, the weld studs are guided from a stud sorting machine by means of compressed air via feed hoses to a stud welding device. The stud welding device is usually fastened to an industrial robot. As the industrial robot operates in a freely movable manner in space and the stud sorting machine is arranged outside the range of movement of the industrial robot, the studs have to be guided from the stud sorting machine to the stud welding device via long, movable feed hoses. Feed lengths of several meters are not uncommon. For this, the feed hoses have to be connected to the stud sorting machine and the stud welding device. Moreover, several hoses are often to be connected to each other via so-called connector couplings or feed hose disconnection points. Because of the mobility of the industrial robot and the compressed air transport of the studs inside the feed hoses, the latter are at risk of cracking.

In the case of damage to a feed hose it must be replaced. In order to prevent the studs from shooting out when the feed hoses are disconnected from each other or a feed hose is disconnected from the stud sorting machine or from the stud welding device, to date feed hose disconnection points have been used, which are monitored by electrical safety switches. When the feed hoses are inserted at the feed hose disconnection point, studs can be conveyed as the electrical safety switches are closed as a result. If a feed hose is disconnected from the disconnection point, the electrical safety switch is opened. The feeding of the studs is thereby electrically and/or pneumatically interrupted.

### SUMMARY OF THE INVENTION

An object of the present invention is to provide a simplified arrangement in which weld studs or other joining elements being delivered to an installation machine or robot are mechanically prevented from coming out of a disconnected feed hose and the disconnection of the feed hose can be made easier.

In particular, the present invention provides a joining element feeding unit with a connector coupling which has a connector plug and a connector socket. By pushing the connector plug into the connector socket they can be transferred reversibly from a disconnected state into a state in which they are connected to each other. The connector plug is penetrated by a cylindrical recess (passage) formed along the cylinder axis Z_{S}. The connector socket is likewise penetrated by a cylindrical recess (passage) formed along the cylinder axis Z_{B}. In the connected state, the axes Z_{S} and Z_{B} are aligned with each other along an alignment axis Z_{F} and the cylindrical passages are connected to each other. The connector plug has a plug-in element with a radial widening. The connector socket has a push-in opening for the plug-in element, a locking element, and a latching element.

The locking element is designed in such a way that, in the disconnected state, it is in a locked position, in which the cylindrical passage of the connector socket is at least partially blocked by the locking element and thus is not passable for joining elements. Furthermore, the locking element is designed in such a way that, in the connected state, it is in an open position, in which the cylindrical passage is passable for joining elements. The push-in opening is designed in such a way that the plug-in element can be pushed from a push-in direction, in which the axes Z_{S} and Z_{B} are not aligned with each other, into an inserted position in the connector socket. Furthermore, the push-in opening is designed in such a way that, after the pushing-in, connector plug and connector socket can be transferred into the connected state through a latching movement. The locking element can be transferred out of the locked position into the open position through the latching movement. Furthermore, the latching element engages behind the radial widening through the latching movement in order to prevent the disconnection of connector plug and connector socket in the opposite direction along the axis Z_{F}, that is, to prevent the separation of the connector plug and connector socket along the axis Z_{F}.

Examples according to the invention of joining elements are studs, in particular weld studs, bolts, nuts, balls, nails, rivets or the like, wherein studs, in particular weld studs, are preferred. In an embodiment of the feeding units according to the invention it is preferred for these to be selected from the group which consists of studs, in particular weld studs, bolts, nuts, balls, nails and rivets, wherein studs, in particular weld studs, are preferred.

A joining element feeding unit includes at least two parts, which are connected to each other via the connector coupling. According to the invention, these include feed hoses, in which joining elements can preferably be transported by compressed air. According to the invention, however, these also include joining element sorting machines or joining element conveyors and a joining element installation device such as a welding device, for example a welding head. The joining element sorting machine includes the joining elements and transports them via one or more feed hoses to the joining element installation device. At the joining element sorting machine/feed hose, feed hose/feed hose and feed hose/installation device junctions, connector couplings according to the invention can be used to connect these parts of the feeding unit. It is preferred for a connector socket of the connector coupling according to the invention to sit at the joining element sorting machine and for a connector plug to sit at the welding device. These can be connected to each other via one or more feed hoses, which have a connector socket on one side and a connector plug on the other side. The feed hoses may have an inner hose which is surrounded by a protective hose, i.e. they preferably have a 2-part design. The joining elements are transported in the inner hose; the protective hose serves as additional security against joining elements coming out if the inner hose is damaged.

By the term “reversible” in connection with the pushing of the connector plug into the connector socket it is meant that connector plug and connector socket can be placed in a connected state and a disconnected state as often as desired.

By the expression “penetrated by a cylindrical passage formed along the cylinder axis Z_{S}/Z_{B}” it is meant that connector plug and connector socket are designed in such a way that the cylindrical passage, in the connected state, makes it possible for the joining elements to pass through connector plug and/or connector socket.

The expression “in the connected state, the axes Z_{S} and Z_{B} are aligned with each other along an alignment axis Z_{F}” is to include, on the one hand, that the corresponding axes lie in the center of the direction of extension of the passages and, on the other hand, that they are identical.

By the expression “the cylindrical passages are connected to each other”, it is to be explained that the cylindrical passages of the connector plug and of the connector socket adjoin each other in the connected state in such a way that it is made possible for the joining elements to pass through the connector coupling.

In an embodiment of the present invention, the connector plug and the connector socket preferably each have, at one end, a connecting element for the feeding units for joining elements. These connecting elements are preferably located at the opposite ends from the push-in opening of the connector socket and of the plug-in element of the connector plug. These connecting elements are preferably designed hollow-cylindrical, with the result that, for example, a feeding unit part comprising a feed hose can be fitted onto or inserted into the connecting elements and then connected thereto using a fastening element such as a suitable hose clamp. It is preferred for the inner hose of the feed hose to be inserted into a cavity of the connecting element and for the protective hose to be fitted onto the outside of the hollow cylinder.

Because connector plug and connector socket typically have cylindrical passages inside them for transporting the joining elements, connector plug and connector socket are preferably designed as elements running radially around the cylindrical passages.

In an embodiment of the present invention, the plug-in element is preferably a plug nipple, the radial widening of which is a radial ridge, which can be a circumferential radial ridge or a radial ridge which is interrupted at one or more points about the circumference. The diameter of the plug nipple is preferably smaller than the diameter of the part of the connector plug adjoining it. Thus, the connector plug preferably has a stop comprising a stop surface at the end lying opposite the outer end of the plug nipple, the stop preventing the connector plug from being pushed into the push-in opening of the connector socket beyond the plug nipple.

The push-in opening of the connector socket is designed according to the invention in such a way that the plug-in element can be pushed into the push-in opening from a push-in direction in which the axes Z_{S} and Z_{B} are not aligned with each other. According to the invention this includes several possible ways in which the connector plug can be connected to the connector socket. In one embodiment, the push-in opening can be designed in such a way that the plug-in element can be pushed from a push-in direction, in which the axes Z_{S} and Z_{B} are aligned parallel to each other during the pushing-in, into the push-in opening. According to a preferred embodiment, however, the push-in opening is designed in such a way that the plug-in element, which preferably has a stop, can be pushed into the push-in opening from a push-in direction in which the axes Z_{S} and Z_{B} are inclined relative to each other, i.e. do not run parallel to each other, into the push-in opening. In the first-mentioned case, the latching movement for the transfer into the connected state takes place at the moment at which the parallel axes Z_{S} and Z_{B} transition into their aligned position. In the more preferred variant, the axes Z_{S} and Z_{B} that are inclined relative to each other are transferred into their aligned position at the moment of the latching movement. In this latter embodiment it is preferred for the push-in opening to be designed such that, during the latching movement, the axes Z_{S} and Z_{B} are inclined relative to each other at an angle in the range of from 30° to 60°.

According to the invention, the locking element is designed in such a way that on the one hand, when the connector plug and connector socket are in the disconnected state, it is in a locked position, in which the cylindrical passage of the connector socket is not passable for joining elements, and that on the other hand, in the connected state, it is in an open position, in which the cylindrical passage is passable for joining elements. By “passable” is herein meant that the locking element does not block the cylindrical passage of the connector socket, with the result that the cylindrical passage is designed in such a way that joining elements can pass through the connector socket from one end to the other end. By “not passable” is herein meant that the locking element blocks the cylindrical passage in such a way that joining elements cannot pass through the connector socket from one end to the other end. The locking element is preferably located on the side of the connector socket on which the push-in opening for the plug-in element is arranged. The locking element preferably adjoins the push-in opening and is preferably partially enclosed by the wall surrounding the cylindrical passage.

The locking element can be designed spherical, cylindrical or stud-shaped.

If the locking element is designed spherical or cylindrical, the sphere or the cylinder preferably has a continuous hole. The continuous hole preferably has a receiving opening for receiving the plug-in element of the connector plug on one side. In the connected state of the connector coupling according to the invention, at least a portion of the hole may serve as a passage for the joining elements. In the connected state of the connector coupling according to the invention, the axis of the hole is preferably aligned with the alignment axis Z_{F}, i.e. the hole of the locking element is located in a concentric position relative to the alignment axis Z_{F}. In the disconnected state of the connector coupling used according to the invention, the axis of the hole is preferably arranged eccentric relative to the alignment axis Z_{F}, for example in that the spherical or cylindrical locking element is turned such that the axis of the hole is inclined relative to the alignment axis Z_{F}. In this case it is preferred for the latching movement to take place in such a way that the axes Z_{S} and Z_{B} initially inclined relative to each other are transferred into their aligned position, as is described further above as a possible embodiment for the latching movement. As described further above, it is in particular preferred here for the push-in opening to be designed such that, during the latching movement, the axes Z_{S} and Z_{B} are inclined relative to each other at an angle in the range of from 30° to 60°. In this way it is guaranteed that—in particular in the case of a spherical locking element—although the cylindrical passage can prevent joining elements from passing through, the cylindrical passage is not completely blocked. This has the advantage that compressed air can further escape from the connector socket. In this way an undesired pressure build-up in the feeding units can be avoided. In other words, the hole of the locking element is designed such that, in the locked position at an angle of inclination of the axis of the hole to the axis Z_{B} in the range of from 30° to 60°, compressed air can escape from the push-in opening.

If the locking element is designed stud-shaped, the stud is located in the cylindrical passage of the connector socket in the disconnected state of the connector coupling according to the invention. In the connected state of the connector coupling according to the invention, the stud preferably does not obstruct the cylindrical passage of the connector socket. The stud is preferably pushed away during the latching movement in such a way that the cylindrical passage extends from one end of the connector socket to the other. If the locking element is stud-shaped, both variants of the latching movement mentioned further above are conceivable according to the invention.

As the transition from a disconnected state to a connected state of connector plug and connector socket is reversible, the connector plug can be disconnected from the connector socket again. Here, the pushing of the connector plug into the connector socket required for the connection and the subsequent latching movement are carried out in the reverse order, called “pulling out” and “unlatching” or “unlatching movement” in the following. During the transition from the connected state to the disconnected state, an unlatching movement of the connector plug is thus carried out first, in which the axis Z_{S} is brought out of the alignment axis Z_{F}. The locking element is designed such that it takes up the locked position during the unlatching movement. Joining elements are thereby prevented from coming out of the connector socket.

In an embodiment of the present invention, the connector socket has a force element, which provides a biasing force to the locking element such that the locking element takes up the locked position during the transition from the connected state to the disconnected state of the connector coupling according to the invention. This is preferably brought about by the previously mentioned unlatching movement. Here, the force element is preferably designed in such a way that the locking element is compression-loaded in the open position. The locking element thereby transitions from the open position into the locked position during the transition from the connected state to the disconnected state. During the connection of the connector plug to the connector socket through the latching movement, a force must be applied in order to bring the locking element from the locked position into the open position. This force to be applied is so great that an operating person is not capable of bringing the locking element from the locked position into the open position with their bare hands. Injuries caused by joining elements shooting out can thereby be avoided. The force element can be a spring or an elastic material, for example a rubber.

The latching element of the connector socket is preferably an element which engages behind the radial widening in the connected state of the connector coupling according to the invention. The latching element can be formed as a partially ring-shaped element, the imaginary center of the circle of which runs around the axis Z_{B}. It is preferably located at the end of the connector socket at which the push-in opening is arranged, preferably such that the ring shape of this element is interrupted by the push-in opening. At the furthest end the latching element preferably has a thickening which runs radially and in the direction of the imaginary center of the circle. In this way, this thickening can engage behind the radial widening of the plug-in element, in order to prevent the disconnection of connector plug and connector socket in the opposite direction along the axis Z_{F}.

The connector plug can furthermore have a sliding element, which is designed in such a way that only by moving the sliding element can the plug-in element be introduced into the push-in opening. Furthermore, the sliding element is preferably designed in such a way that it can be moved out of a covering position into an open position. In the covering position the sliding element prevents the unlatching movement from being carried out. For this, it must first be brought out of the covering position into the open position. In other words, the sliding element is designed in such a way that the unlatching movement cannot be carried out until the sliding element has been moved, for example out of the covering position into the open position. The sliding element is preferably designed such that it surrounds the connector plug in a ring-like manner. In order to move it out of the covering position into the open position, it is preferably moved along the axis Z_{S}. The sliding element is preferably designed in such a way that a force must be applied in order to move it out of the covering position into the open position. For this purpose, springs can for example be used, which are preferably correspondingly arranged between the sliding element and the part bordering the cylindrical passage of the connector plug.

The connector coupling according to the invention has particular application in connecting feeding units for joining elements in a welding system which preferably has a joining element sorting machine, feeding units and a welding head.

In a further embodiment, the present invention also relates to a method for connecting/disconnecting parts of a feeding unit according to the invention for joining elements by means of the named connector coupling. The method comprises the following steps (a) and (b), or (a′) and (130, or (a), (b), (a′) and (130:
(a) pushing the plug-in element of the connector plug into the push-in opening of the connector socket;
(b) latching the connector plug into the connector socket, wherein the locking element of the connector socket is transferred out of the locked position into the open position and the latching element engages behind the radial widening, in order to prevent the disconnection of connector plug and connector socket in the opposite direction along the axis Z_{F};
(a′) unlatching the connector plug from the connector socket, wherein the locking element of the connector socket is transferred out of the open position into the locked position and the latching element is removed from the radial widening;
(b′) pulling the plug-in element of the connector plug out of the push-in opening of the connector socket.

All features structurally and functionally defining the connector coupling according to the invention are preferably also features of the method according to the invention.

These and other advantages and features of the invention will be apparent from the following description of representative embodiments, considered along with the accompanying drawings.

### BRIEF DESCRIPTION OF THE DRAWINGS

FIG. 1 shows a connector coupling that can be used according to the invention in the connected state, to which feed hoses of a feeding unit are attached at both ends.

FIG. 2 shows a connector plug of a connector coupling that can be used according to the invention.

FIG. 3 shows a connector socket of a connector coupling that can be used according to the invention.

FIG. 4 shows a connector coupling that can be used according to the invention in the connected state as in FIG. 1, which additionally has a force element for the locking element.

FIGS. 5 to 9 show different positions of the connector coupling when carrying out the method according to the invention, with which the connector coupling that can be used according to the invention can be brought from the disconnected state into the connected state.

### DESCRIPTION OF REPRESENTATIVE EMBODIMENTS

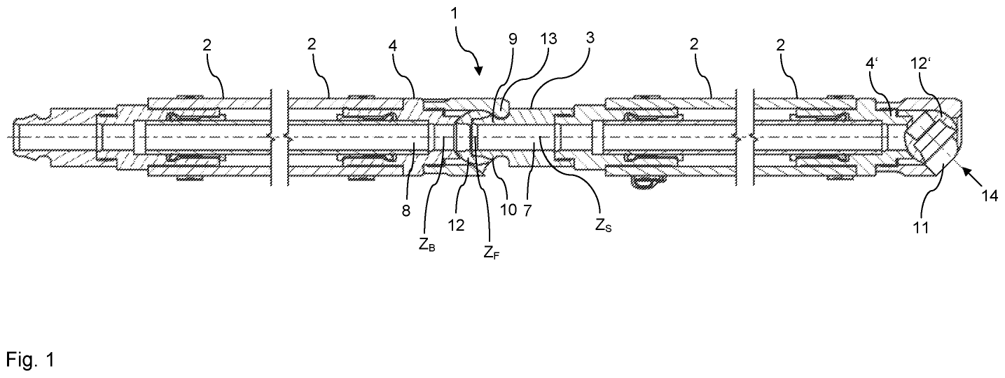

FIG. 1 schematically shows a view of a connector coupling 1 that can be used according to the invention in the connected state, to which feed hoses of a feeding unit 2 are attached at both ends. The connector plug 3 has a cylindrical passage 7, through which joining elements can pass. Similarly, in the connected state the connector socket 4 has a cylindrical passage 8, through which joining elements can likewise pass. In the connected state the cylinder axes Z_{S} and Z_{B} are aligned along the alignment axis Z_{F}. The connector plug 3 has a plug-in element 9 formed as a plug nipple, which has a radial widening 10. The connector socket 4/4′ has, at the end facing the push-in opening 11, a spherical locking element 12/12′ inside it with a hole which is located in a concentric position relative to the alignment axis Z_{F} in the connected state. In the disconnected state the locking element 12′ is in the locked position, in which the hole is arranged eccentric with the result that, in the disconnected state, the cylindrical passage 8 of the connector socket 4′ is blocked and joining elements cannot come out. In order that the plug-in element 9 can be pushed into the connector socket 4′, the connector socket 4′ has a push-in opening 11, through which the plug-in element 9 can be pushed into a receiving opening of the locking element 12 and 12′. The push-in direction 14 of the connector plug 3 is such that the axes Z_{B} and Z_{S} are not aligned with each other, and even have to be at an inclined angle relative to each other in the embodiment shown in FIG. 1. After the connector plug 3 has been pushed into the connector socket 4 to an inserted position, connector plug 3 and connector socket 4 are brought, through a latching movement, into the connected state, in which the axes Z_{S} and Z_{B} are aligned with each other. It is brought about through the latching movement that the locking element 12′ in a locked position turns into a locking element 12 in an open position. Furthermore, it is brought about through the latching movement that the latching element 13 engages behind the radial widening 10 of the plug-in element 9, whereby the disconnection of connector plug 3 and connector socket 4 in the opposite direction along the axis Z_{F} is prevented. In FIG. 1, feed hoses of a feeding unit 2 are attached, at the ends of which lying opposite the connector coupling in each case a connector plug 3 and a connector socket 4 are again located.

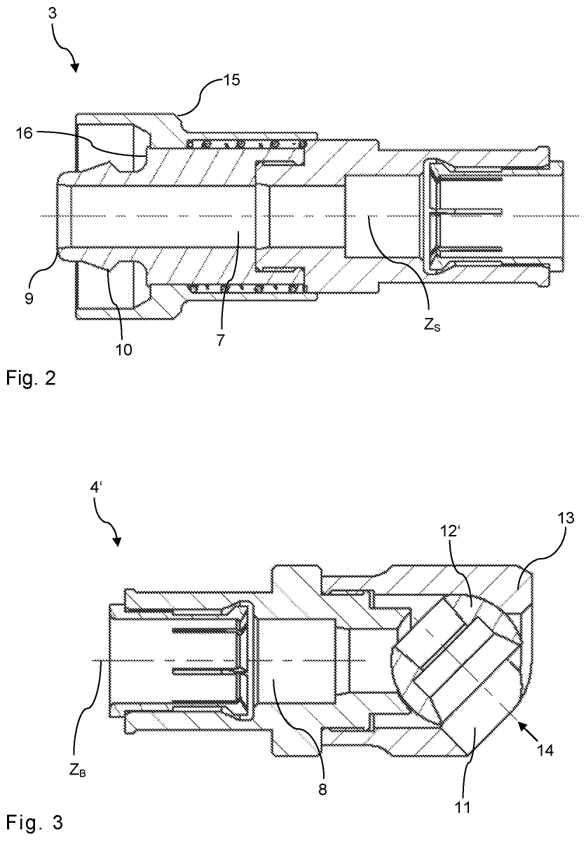

FIG. 2 shows a connector plug 3 in the disconnected state with a plug-in element 9 formed as a plug nipple, which has a radially circumferential ridge as radial widening 10. The cylindrical passage 7 guarantees that weld studs can be guided through the connector plug 3 along the axis Z_{S}. The stop 16 prevents the connector plug 3 from being pushed too far into the push-in opening 11 of the connector socket 4 and 4′. The connector plug 3 in FIG. 2 has a sliding element 15, which is displaceable along the direction of the axis Z_{S}. The sliding element 15 is formed ring-shaped around the connector plug 3 and can be brought out of a covering (extended) position into an open (retracted) position. In the extended position, the plug-in element 9 is substantially surrounded by the sliding element 15. In the retracted position, the sliding element 15 is in a position in which it does not surround the plug-in element 9. The purpose of the sliding element 15 is that it covers both the push-in opening 11 and latching element 13 in the connected state of connector plug 3 and connector socket 4. In order for it to be held in the extended position, the sliding element can have springs.

FIG. 3 shows a connector socket 4′ in the disconnected state. The connector socket 4′ has a cylindrical passage 8, through which weld studs can be guided along the axis Z_{B} in the connected state. In order that the joining elements cannot come out of the connector socket 4′ in the disconnected state, the locking element 12′ is in a locked position. The locking element 12′ is formed spherical here and has a hole, the axis of which is not aligned with the axis Z_{B} in the disconnected state. The hole has a size which makes it possible for joining elements to be able to pass through the locking element 12 in the connected state. The locking element 12 and 12′ is movable in such a way that it can be brought from a locked position into an open position. In the locked position, the locking element 12′ is arranged such that the axis of the hole points in the direction of the center of the push-in opening 11. The connector plug 3 can be pushed from the push-in direction 14 into the connector socket 4′.

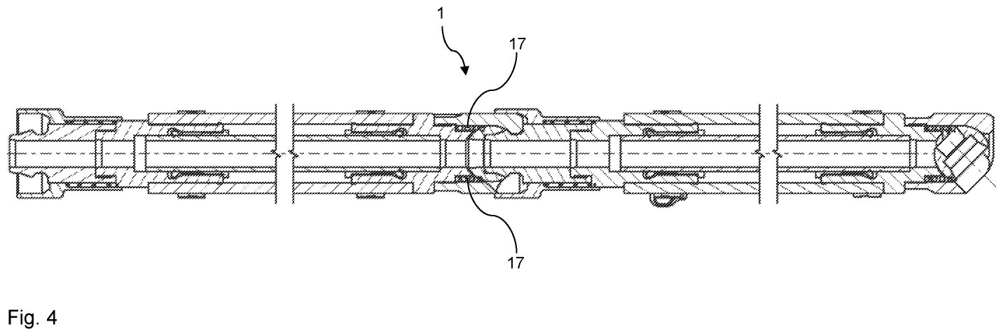

FIG. 4 shows a connector coupling 1 according to the invention in the connected state as in FIG. 1, which additionally has a force element 17 for the locking element 12/12′. The force element 17 guarantees that during the disconnection of connector plug 3 and connector socket 4 the locking element 12/12′ is brought into the locked position, in which joining elements cannot come out of the connector socket 4′.

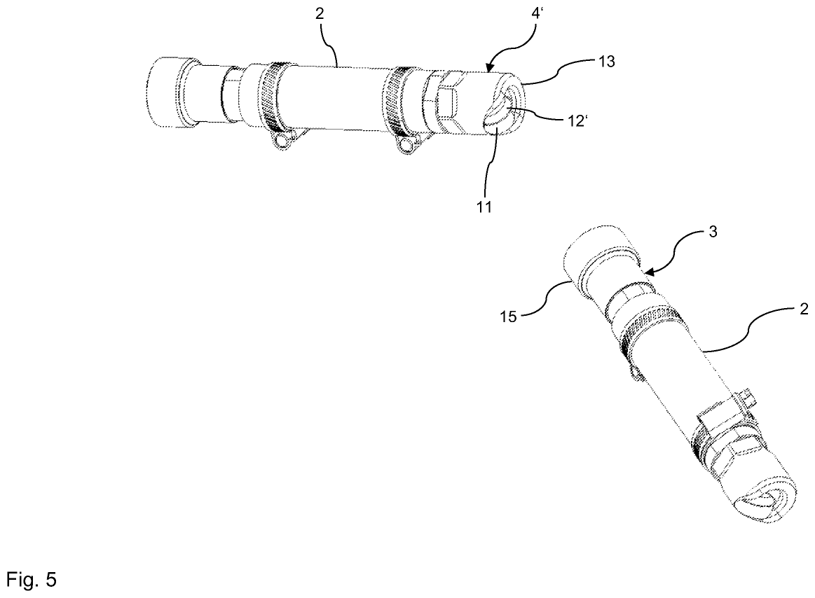

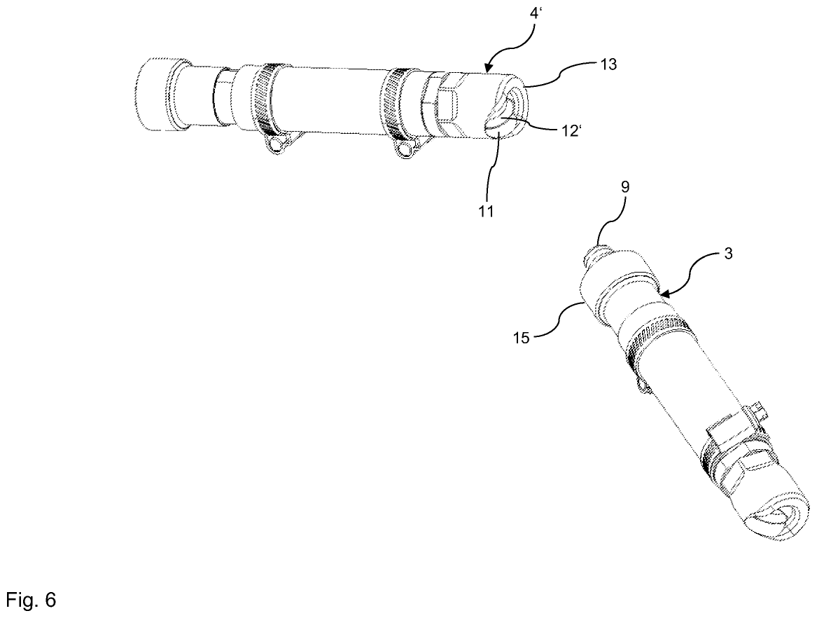

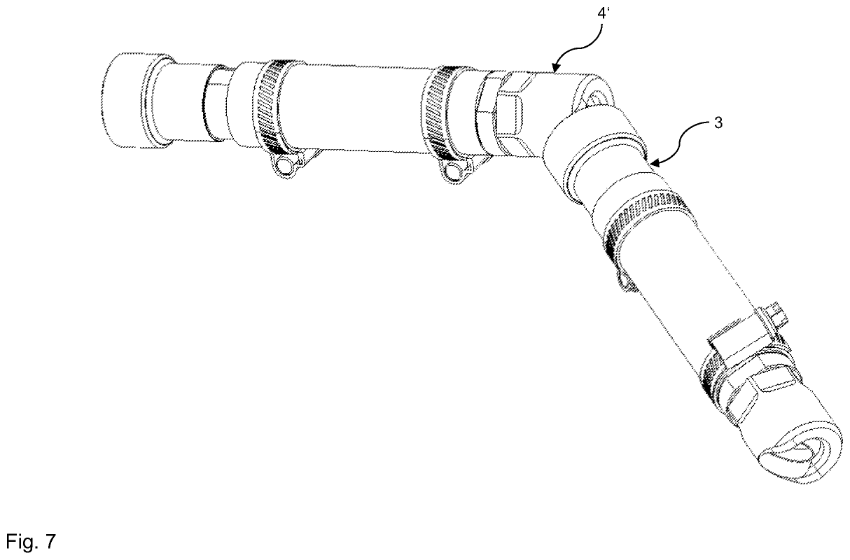

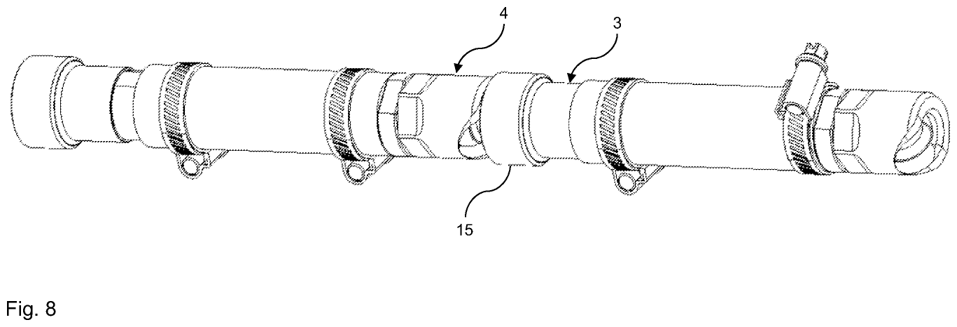

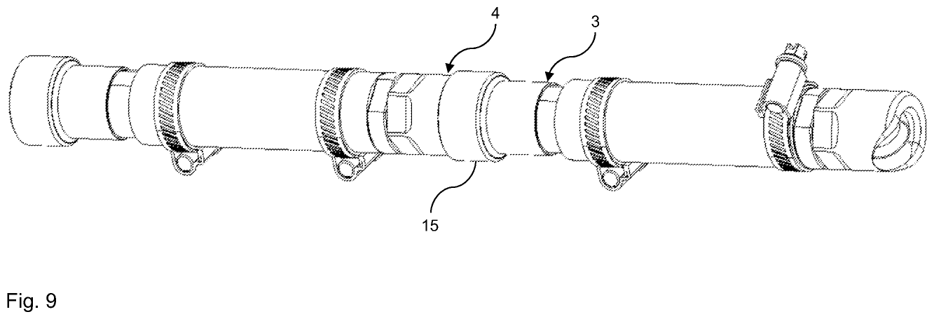

FIG. 59 show the various steps which are carried out when the connector coupling is brought from the disconnected state into the connected state. A feed hose of a feeding unit 2, at the end of which a connector socket 4 is located, is attached to the connector plug 3. The connector plug 3 is covered with a sliding element 15. In FIG. 5 the sliding element 15 is in the extended position, in which it covers the plug-in element 9. In order that the plug-in element 9 can be pushed into the push-in opening 11 of the connector socket 4′, the sliding element 15 must be transferred out of the extended position into the retracted position, in which the plug-in element 9 is no longer concealed by the sliding element 15. The latter position is shown in FIG. 6. With the sliding element 15 in the retracted position, the plug-in element 9 can be pushed into the push-in opening 11 to an inserted position. This is effected from a push-in direction 14, in which the axes Z_{S} and Z_{B} are not aligned with each other. FIG. 7 shows the connector plug 3 pushed from the push-in direction 14 into the push-in opening 11 of the connector socket 4 to the inserted position before the latching movement. FIG. 8 shows connector plug 3 and connector socket 4 connected to each other after the latching movement, in which the axes Z_{S} and Z_{B} are aligned with each other. In FIG. 8 the sliding element 15 is in the retracted position. FIG. 9 shows the sliding element 15 after transfer from the retracted position into the extended position.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

In the above descriptions and the following claims, terms such as top, bottom, upper, lower, vertical, and the like with reference to a given feature are made with reference to the orientation of the structures shown in the drawings and are not intended to exclude other orientations of the structures.

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements which does not have the defined characteristic or feature.

The above-described preferred embodiments are intended to illustrate the principles of the invention, but not to limit the scope of the invention. Various other embodiments and modifications to these preferred embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

### LIST OF REFERENCE CHARACTERS

1 connector coupling
2 feeding unit
3 connector plug
4 connector socket (in the connected state)
4′ connector socket (in the disconnected state)
5 disconnected state of connector plug and connector socket
6 connected state of connector plug and connector socket
7 cylindrical passage of the connector plug
8 cylindrical passage of the connector socket
9 plug-in element
10 radial widening of the plug-in element
11 push-in opening
12 locking element (in the open position)
12′ locking element (in the locked position)
13 latching element
14 push-in direction
15 sliding element
16 stop
17 force element
Z_{S} cylinder axis of the cylindrical passage of the connector plug
Z_{B} cylinder axis of the cylindrical passage of the connector socket
Z_{F} alignment axis

1-11. (canceled)

12. A feeding unit for feeding joining elements, the feeding unit including:
(a) a connector plug having a plug-in element with a radial widening part and also having a plug passage defined along a plug axis through the connector plug;
(b) a connector socket that can be placed alternatively in a connected state and disconnected state with the connector plug, the connector socket having a push-in opening, a locking element, and a latching element, and also having a socket passage defined along a socket axis through the connector socket, the plug axis and the socket axis being aligned with each other along an alignment axis and the plug passage and socket passage being connected to form a continuous passage when the connector plug and connector socket are in the connected state;
(c) wherein when the connector plug and the connector socket are in the disconnected state the locking element is operable to reside in a locked position in which the locking element blocks a portion of the socket passage and the connector socket is positioned to receive the plug-in element in an inserted position from a push-in direction in which the plug axis and the socket axis are not aligned with each other; and
(d) wherein when the plug-in element is in the inserted position the connector plug is movable through a latching movement to (i) move the locking element from the locked position to an open position in which the socket passage is substantially unblocked by the locking element and to (ii) place the connector plug and connector socket in the connected state with the latching element engaging a rear surface of radial widening part in position to prevent a separation of the connector plug and connector socket along the alignment axis.

13. The feeding unit of claim 12 wherein the joining elements are selected from the group consisting of weld studs, bolts, nuts, balls, nails, and rivets.

14. The feeding unit of claim 12 wherein connector plug and connector socket each have a connecting element for connecting to a respective feed hose of the feeding unit.

15. The feeding unit of claim 12 wherein the plug-in element comprises a plug nipple and the radial widening comprises a ridge extending around at least part of the circumference of the plug nipple.

16. The feeding unit of claim 15 wherein the diameter of the plug nipple is smaller than the diameter of an adjoining part of the connector plug so that the adjoining part of the connector plug provides a stop surface facing in a direction toward an end of the connector plug having the plug nipple.

17. The feeding unit of claim 12 wherein when the plug-in element is in the inserted position from the push-in direction the plug axis and the socket axis are inclined relative to each other.

18. The feeding unit of claim 12 wherein the locking element is spherical or cylindrical.

19. The feeding unit of claim 18 wherein the locking element includes a continuous hole with a receiving opening for receiving the plug-in element.

20. The feeding unit of claim 12 wherein the connector socket has a force element operative to bias the locking element toward the locked position with sufficient force to move the locking element from the open position to the locked position when the connector plug is moved from the connected state with the connector socket to the disconnected state with the connector socket.

21. The feeding unit of claim 12 wherein the connector plug includes a sliding element movable between an extended position and a retracted position relative to the plug-in element, and wherein when the sliding element is in the extended position with the connector plug and the connector socket in the connected state a portion of the sliding element covers the push-in open of the connector socket.

22. A method of operating a coupling comprising a connector plug and a connector socket, the connector plug having a plug passage defined along a plug axis and the connector socket having a socket passage defined along a socket axis, the method including:
(a) pushing a plug-in element of the connector plug into a push-in opening of the connector socket to an inserted position in the connector socket in which (i) the plug axis and the socket axis are not aligned with each other and (ii) a locking element of the connector socket is in a locked position in which the locking element blocks a portion of the socket passage; and
(b) with the plug-in element in the inserted position, moving the connector plug through a latching movement to (i) move the locking element from the locked position to an open position in which the socket passage is substantially unblocked by the locking element and to (ii) place the connector plug and connector socket in a connected state with a latching element of the connector socket engaging a rear surface of a radial widening part of the plug-in element in position to prevent a separation of the connector plug and connector socket along an alignment axis along which the plug axis and the socket axis are aligned.

23. The method of claim 22 further including:
(a) with the connector plug and the connector socket in the connected state, moving the connector plug through an unlatching movement to (i) allow the locking element to move from the open position to the locked position, to (ii) move the latching element out of engagement with the radial widening part, and to (iii) move the plug axis out of alignment with the socket axis; and
(b) pulling the plug-in element of the connector plug out of the push-in opening of the connector socket.
